(19) United States
(12) Patent Application Publication
(10) Pub. No.: US 2006/0277561 A1
(43) Pub. Date: Dec. 7, 2006

(54) FASTENING DEVICE FOR ELECTRONIC APPARATUS

(76) Inventors: Jun-Feng Mao, Shenzhen (CN); Jin-Feng Liu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,738

(22) Filed: Apr. 27, 2006

(30) Foreign Application Priority Data
Jun. 1, 2005 (CN) 200510035089.6

(51) Int. Cl. G11B 7/00

(52) U.S. Cl. 720/692

(57) ABSTRACT

A fastening device, for planting a component to an electronic apparatus, includes an upper housing, a lower housing and at least one damper. The damper is configured for being received in the component. The damper defines a center hole with opposite top and bottom ends. The upper housing mounts onto the top end of the component. The upper housing integrally forms at least one first clamping part abutting the top end of the damper. The lower housing mounts onto the bottom end of the component. The lower housing integrally forms at least one second clamping part abutting the bottom end of the damper wherein one of the first clamping part and the second clamping part extends through the center hole of the corresponding damper.

### FIELD OF THE INVENTION

The present invention generally relates to a fastening device for fastening a component of the electronic apparatus therein and, more particularly to a fastening device for fastening a traverse module in a data storage device such as an optical disc drive.

### DESCRIPTION OF RELATED ART

In recent years, electronic apparatuses such as optical disc drives, handsets, and notebook computers have gained popular widespread use. A traverse module is a relatively important component of an optical disc drive. The traverse module generally includes a spindle motor, a pickup head and so on. The spindle motor is used for rotating an optical disc arranged thereon. The pickup head is used for projecting a laser beam into the optical disc and receiving the reflection off the optical disc. The traverse module is mounted in the optical disc drive by a fastening device.

As shown in FIG. 8, a fastening device (not labeled) for fastening a traverse module 110 in an optical disc drive (not shown) includes a supporting tray 120, a screw 130, two dampers 140 and a nut 150. The traverse module 110 defines a mounting hole 11 therein. Each of the dampers 140 defines a center hole 141 therein. The dampers 140 are respectively set against two opposite sides of the traverse module 110. The supporting tray 120 defines a screw hole 121 therein, with the center of the mounting hole 111, the screw hole 121, and the holes 141 aligned on a same axis.

The screw 130 passes through the mounting hole 11 and the center holes 141 to engage with the nut 150 for holding the dampers 140 and the traverse module 110 together. A part of the screw 130 protrudes out from the nut 150 to engage into the screw hole 121. Thus, the traverse module 110 is fixed to the supporting tray 120.

The amount of parts needed to fasten a component is proportionally related to the number of procedures, time, and resource needed during assembly. During assembly it is inconvenient to fasten a component using the known method.

Therefore a fastening means with fewer components to lower costs is needed throughout the industry to address the aforementioned deficiencies and inadequacies.

### SUMMARY OF INVENTION

A fastening device, for planting a component to an electronic apparatus includes an upper housing, a lower housing and at least one damper. The damper is configured for being received in the component. The damper defines a center hole with opposite top and bottom ends. The upper housing mounts onto the top end of the component. The upper housing integrally forms at least one first clamping part abutting the top end of the damper. The lower housing mounts onto the bottom end of the component. The lower housing integrally forms at least one second clamping part abutting the bottom end of the damper wherein one of the first clamping part and the second clamping part extends through the center hole of the corresponding damper.

Other systems, methods, features, and advantages of the present fastening device will be or become apparent to one with skill in the art upon examination of the following drawings and detailed description. It is intended that all such additional systems, methods, features, and advantages be included within this description, be within the scope of the present device, and be protected by the accompanying claims.

### BRIEF DESCRIPTION OF DRAWINGS

Many aspects of the present fastening device can be better understood with reference to the following drawings. The components in the drawings are not necessarily to scale, emphasis instead being placed upon clearly illustrating the principles of the present device. Moreover, in the drawings, like reference numerals designate corresponding parts throughout the several views.

FIG. 1 is an exploded, isometric view of a fastening device in accordance with an exemplary embodiment of the present invention, the fastening device including a upper housing, a traverse module, a lower housing and a plurality of dampers;

FIG. 2 is an enlarged view of the upper housing of FIG. 1, viewed from an inverted aspect;

FIG. 3 is an enlarged view of the damper shown in FIG. 1;

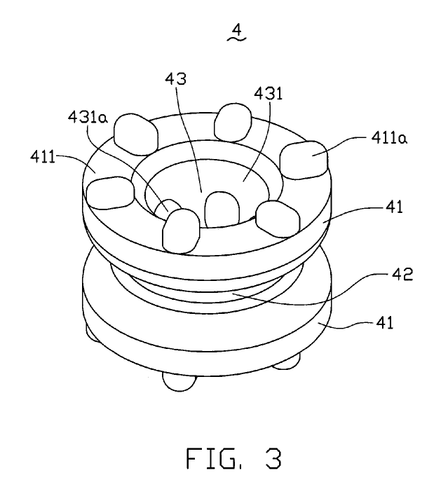

FIG. 4 is a top plane view of the damper shown in FIG. 3;

FIG. 5 is an enlarged view of the traverse module of FIG. 1, with the dampers mounted thereon;

FIG. 6 is an assembled, isometric view of the fastening device of FIG. 1, with a part thereof being cutaway; and

FIG. 7 is a enlarged view of the circular portion VII of FIG. 6.

FIG. 8 is a vertical cross-sectional view of a conventional fastening device.

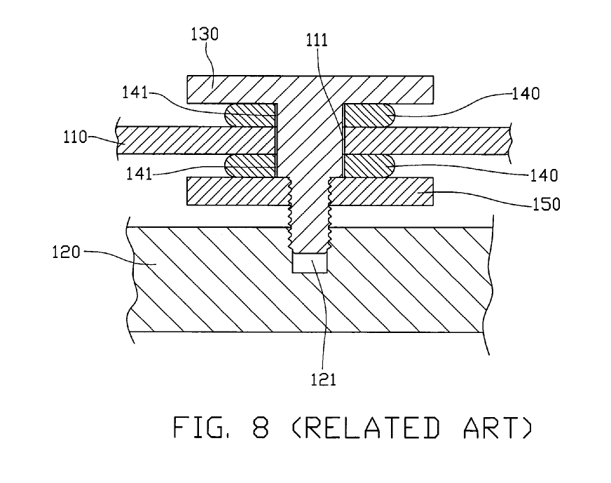

### DETAILED DESCRIPTION

Reference will now be made to the drawings to describe a preferred embodiment of the present fastening device.

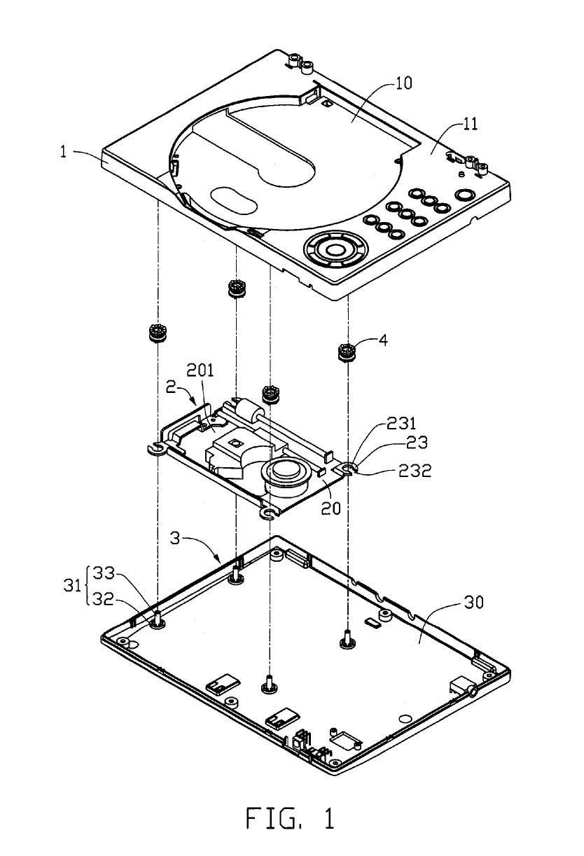

Referring to FIG. 1, an optical disc drive (not shown) includes a fastening device (not labeled) and a traverse module 2. The traverse module 2 is a core of the optical disc drive, which is used for storing information to and reading information from an optical disc (not shown). The fastening device (not labeled) for fastening the traverse module 2 of the optical disc drive includes an upper housing 1, a lower housing 3 and a plurality of supporting members 4. The lower housing 3 is used in conjunction with the upper housing 1 defining a cavity space (not labeled) for receiving the traverse module 2 therein. The supporting members 4 are used for fastening the traverse module 2 between the upper housing 1 and the lower housing 3.

The traverse module 2 includes a base plate 20 and a plurality of mounting members 23. The mounting members 23 are formed at sides of the base plate 20. Each mounting member 23 defines a round mounting hole 231 and an opening gap 232 extending to the side. Each mounting hole 231 is configured for receiving one corresponding supporting member 4. In the example shown, the number of mounting members is four. This is because the main supporting body of the traverse module 2, the base plate 20 has a substantially rectangular shape. The base plate 20, however, may have other shapes adapted for practical disc drive configuration. The base plate 20 also forms other components thereon, such as a pickup head (not labeled), a spindle motor (not labeled) and so forth.

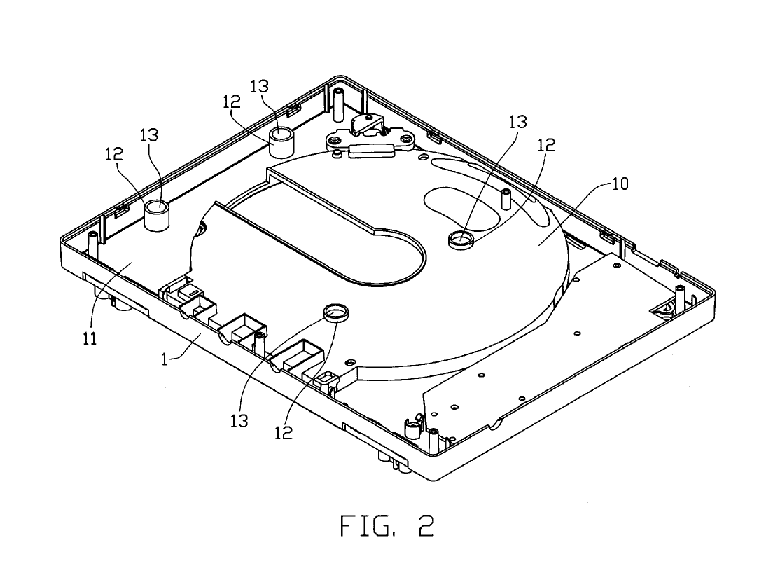

FIG. 2 shows the bottom surface (inside surface) of the upper housing 1. The upper housing 1 includes a platform 10 and a top plate 11. The platform 10 depresses from the middle of the top plate 11 for supporting an optical disc thereon. The upper housing 1 forms a plurality of first clamping parts 12 on the bottom surface of the upper housing 1 wherein the amount of first clamping part 12 corresponds to the amount of mounting members 23. Each first clamping part is a cylindrical barrel protruding out of the bottom surface of the upper plate 11 defining a cylindrical hollow 13 in a center thereof.

Referring to FIG. 1, the lower housing 3 includes a bottom plate 30. A plurality of second clamping parts 31 is formed on the bottom plate 30 corresponding to the mounting members 23. Each second clamping part 31 extends outward from an inner surface of the bottom plate 30. The second clamping part 31 includes a cylindrical barrel protrusion 32 and a post 33 extending upwardly from the center of the protrusion 32 wherein. The post 33 passes through the supporting member 4. A diameter of the post 33 is less than that of the protrusion 32.

Referring to FIGS. 1,2, and 3, the supporting member 4 exhibits elastic properties that can be made of rubber or any other elastic materials. The supporting member 4 is configured to be a spindle-shaped like damper. The center axis of the supporting member 4 (not labeled) lies perpendicular to the base plate 20 of the traverse module 2. In a center portion of the supporting member 4, an axially extending center hole 43 is defined for allowing the corresponding post 32 of the lower housing 3 to extend therethrough. The supporting member 4 includes two annular end parts 41 in the opposite top and bottom ends and a middle part 42. The middle part 42 has a ring-shaped horizontal section (not shown). The middle part 42 is axially sandwiched between the two annular end parts 41. The outer diameter of the middle part 42 is smaller than that of the two annular end parts 41. The two annular end parts 41 are axially symmetrical to each other. Each annular end part 41 has an annular surface 411 at a distal end thereof.

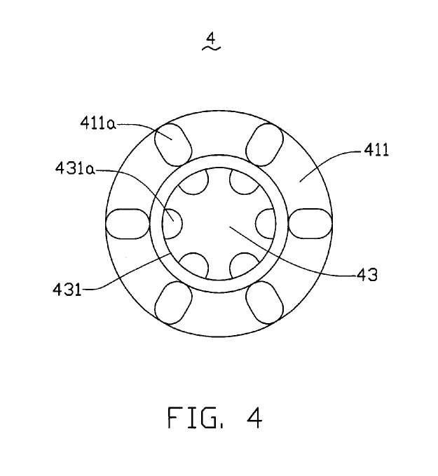

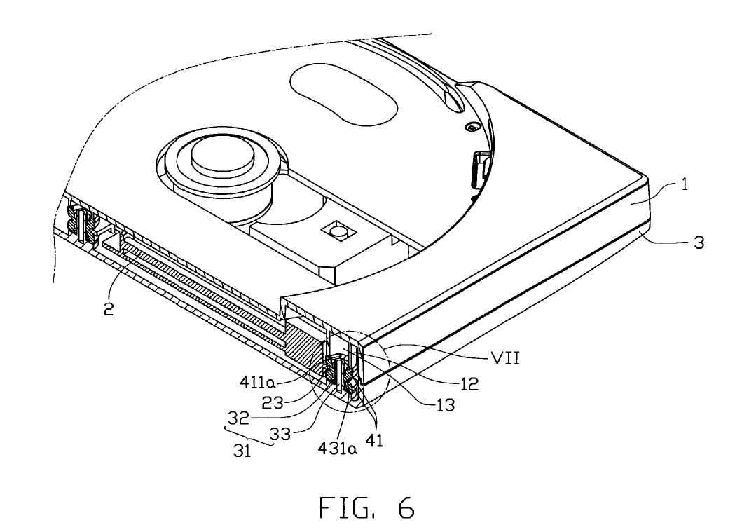

Referring also to FIGS. 4 and 6, a number of juts 411a are formed on the annular surface 411 at uniform intervals. The juts 411a are configured for contacting with the first clamping part 12 and the second clamping part 31. A number of juts 431a are formed on an inner surface 431 of the supporting member 4 at uniform intervals for contacting with the corresponding post 32.

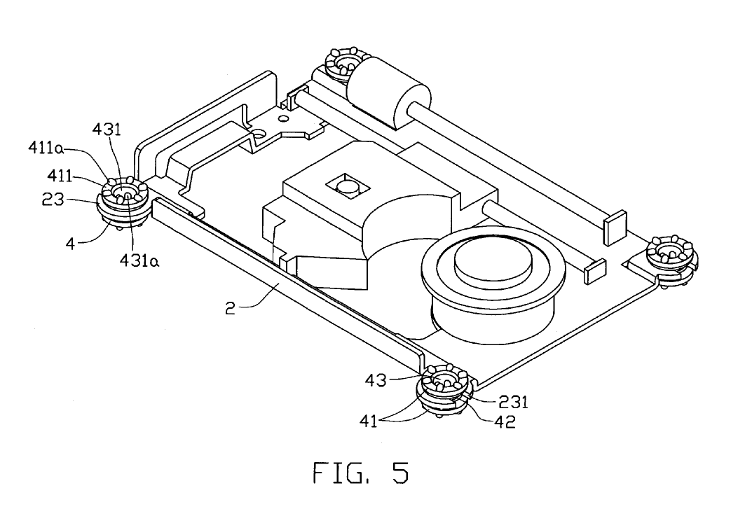

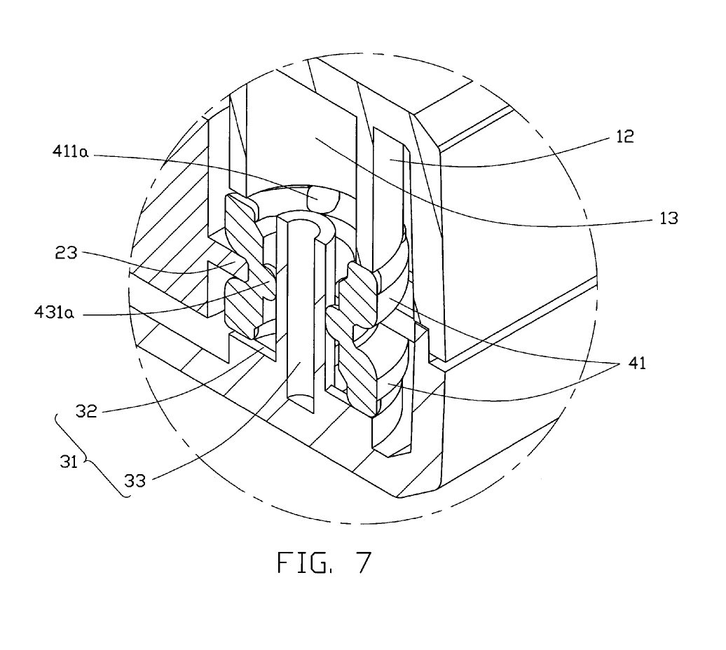

Referring to FIGS. 5, 6 and 7, in assembly, each supporting member 4 is fittingly received in the corresponding mounting member 23 via the gap 232 of the traverse module 2, with the middle part 42 of the supporting member 4 being received in the mounting hole 231 and the annular end parts 41 of the supporting member 4 clamping on topside and underside of the mounting member 23. Each post 32 is then passed through the corresponding center hole 43 of the supporting member 4 and partially received in the cylindrical hollow 13 of the corresponding first clamping part 12. The cylindrical hollow 13 is used to avoid a collision between the top of post 32 and the top plate 11 when the fastening device is compressed by an outer force axially wherein the supporting member 4 deforms. The first clamping part 12 abuts the top end of the supporting member 4 and the second clamping part 31 abuts the bottom end of the supporting member 4. Thus, the supporting member 4 is clamped between the first clamping part 12 and the second clamping part 31. The traverse module 2 is thus fixed between the upper housing 1 and the lower housing 3.

Because the first clamping part 12 and the second clamping part 31 may be integrally formed with the upper housing 1 and the lower housing 3 respectively, the structure of the fastening device is so simple that it is conveniently assembled. Thus, the fastening device will have a lower cost production because it has lesser parts and assembly procedures. Moreover, the first clamping part 12 can also be integrally created within the lower housing 3 and the second clamping part 31 can also be integrally installed within the upper housing 1. The fastening device can also be used to fix other components in other electronic apparatus such as handsets, notebook computers and PVRs (Personal Video Recorders).

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. A fastening device for planting a component to an electronic apparatus, the fastening device comprising:
at least one damper for supporting the component, the damper being configured for being received in the component, the damper axially defining a center hole with opposite top and bottom ends;
an upper housing mounting onto the top end of the damper, the upper housing integrally forming at least one first clamping part abutting the top end of the damper; and
a lower housing mounting on the bottom end of the damper, the lower housing integrally forming at least one second clamping part abutting the bottom end of the damper wherein one of the first clamping part and the second clamping part extends through the center hole of the corresponding damper.

2. The fastening device according to claim 1, wherein the second clamping part comprises a protrusion and a post, and the post extends upwardly from the center of the protrusion.

3. The fastening device according to claim 1, wherein the damper is an elastic member.

4. The fastening device according to claim 1, wherein the damper comprises a middle part connecting the top and bottom ends, and the diameter of the middle part is smaller than that of the two end parts.

5. The fastening device according to claim 4, wherein the middle part is received in the component, and the two end parts clamp on the topside and the underside of the component.

6. The fastening device according to claim 4, wherein each of the end parts has an annular surface, a plurality of juts are formed on the annular surface at uniform intervals.

7. The fastening device according to claim 1, wherein the damper has an inner surface, a plurality of juts are formed on the inner surface at uniform intervals.

8. A data reading device, comprising:
a traverse module for storing information to and reading information from a medium, the traverse module comprising at least one mounting member thereon;
at least one supporting member for supporting the traverse module, and the supporting member being received in the traverse module;
an upper housing mounting onto a top side of the traverse module, comprising at least one first clamping part;
a lower housing mounting onto a back side of the traverse module, comprising at least one second clamping part, the second clamping part passing through the supporting member and being partially received in the first clamping part, and the supporting member being clamped between the first clamping part and the second clamping part.

9. The data reading device according to claim 7, wherein the main body comprises a plate, and the mounting member is formed on a side of the plate.

10. The data reading device according to claim 8, wherein the mounting member defines a mounting hole therein, and the supporting member is received in the mounting hole.

11. The data reading device according to claim 7, wherein the first clamping part protrudes out of the bottom surface of the upper housing and defines a hollow therein.

12. The data reading device according to claim 10, wherein the second clamping part extends upwardly from the inner surface of the lower housing and comprises a protrusion and a post, and the post is in center of the protrusion.

13. The data reading device according to claim 11, wherein the post extends upwardly from a center of the protrusion and passes through the supporting member wherein the post is partially received in the hollow.

14. A data storage device comprising:
a traverse module comprising a mounting portion;
a damper mounted to the mounting portion, the damper axially defining a center hole with opposite top and bottom ends;
an upper housing located at a top side of the traverse module, the upper housing comprising a first clamping part abutting the top end of the damper; and
a lower housing located at a bottom side of the traverse module, the lower housing comprising a second clamping part abutting the bottom end of the damper, one of the first and second clamping parts extending through the center hole of the damper, the other of the first and second clamping parts defining a hollow corresponding to said one.
